(19) United States
(12) Patent Application Publication
(10) Pub. No.: US 2015/0241578 A1
(43) Pub. Date: Aug. 27, 2015

(54) SCINTILLATOR STACK, DEVICE INCLUDING THE SCINTILLATOR STACK, AND METHOD FOR MAKING THE SCINTILLATOR STACK

(71) Applicant: SAINT-GOBAIN CERAMICS & PLASTICS, INC., Worcester, MA (US)

(72) Inventors: Peter R. Menge, Novelty, OH (US); Kan Yang, Solon, OH (US); Michael R. Mayhugh, Shaker Heights, OH (US); Jan J. Buzniak, Solon, OH (US); Mark R. De Guire, Cleveland Heights, OH (US); James McGuffin-Cawley, Cleveland, OH (US)

(21) Appl. No.: 14/634,332

(22) Filed: Feb. 27, 2015

Related U.S. Application Data
(60) Provisional application No. 61/945,620, filed on Feb. 27, 2014.

(51) Int. Cl. G01T 3/06; B29C 47/06

(52) U.S. Cl. CPC G01T 3/06; B29C 47/065; B29K 2101/12

(57) ABSTRACT

A scintillator stack includes a neutron-sensitive particulate material and a scintillator particulate material dispersed in separate layers. The scintillator stack can be included in a scintillator device. The scintillator stack can be made using a co-extrusion method.

### CROSS-REFERENCE TO RELATED APPLICATION(S)

This application claims priority to and the benefit of U.S. Provisional Patent Application No. 61/945,620 filed Feb. 27, 2014, and is incorporated herein by reference in its entirety.

### FIELD OF THE DISCLOSURE

This disclosure relates to a scintillator stack, apparatuses including scintillator stacks, and methods for making scintillator stacks.

### DESCRIPTION OF RELATED ART

Scintillator-based detectors are used in a variety of applications, including research in nuclear physics, oil exploration, field spectroscopy, container and baggage scanning, and medical diagnostics. When a scintillator material of the scintillator-based detector is exposed to ionizing radiation, the scintillator material absorbs energy of incoming radiation and scintillates, remitting the absorbed energy in the form of photons. For example, a neutron detector can emit photons after absorbing a neutron. Further improvements of scintillator-based detectors are desired.

### BRIEF DESCRIPTION OF THE DRAWINGS

Embodiments are illustrated by way of example and are not limited by the accompanying figures.

FIG. 1 is an illustration of a neutron-sensitive apparatus in accordance with an embodiment described herein.

FIG. 2 is a cross-sectional view of a neutron sensor in accordance with an embodiment described herein.

FIG. 3 is an illustration of a neutron-sensitive layer disposed over a scintillator layer in accordance with an embodiment described herein.

FIG. 4 is an schematic of a co-extrusion method in accordance with an embodiment described herein.

FIG. 5 includes an optical microscope image of a scintillator stack in accordance with an embodiment described herein.

FIG. 6 includes a graph characterizing the expected energy deposition distributions into a scintillator in accordance with an embodiment described herein.

FIG. 7 includes a graph characterizing the energy spectrum for a scintillator in accordance with an embodiment described herein.

FIG. 8 includes a graph characterizing the pulse shape spectrum for a scintillator in accordance with an embodiment described herein.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention. The use of the same reference symbols in different drawings indicates similar or identical items.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

The term “averaged,” when referring to a parameter, is intended to mean a median value for the parameter.

The term “elemental” before an atomic element is intended to mean to the atomic form of the atomic element that is not part of a chemical compound. For example, elemental Zn refers to zinc in its atomic form and not as part of a zinc compound, such as ZnS.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The term “rare earth” or “rare earth element” is intended to mean Y, Sc, and the Lanthanoids (La to Lu) in the Periodic Table of the Elements.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and radiation detection arts.

A scintillator stack can include a neutron-sensitive particulate material and a scintillator particulate material. The neutron-sensitive particulate material can be dispersed in a polymer matrix in a neutron-sensitive layer and the scintillator particulate material can be dispersed in a polymer matrix in a separate scintillator layer. The layers of the scintillator stack can be manufactured using a co-extrusion method, such as a forced polymeric micro-layer co-extrusion method.

A neutron can enter the neutron-sensitive layer and be captured by the neutron-sensitive particulate material, which in turn, emits a charged particulate material. Energy of the charged particulate material can be captured by the scintillator layer, which in turn, emits scintillation light. The scintillator stack can be used in a neutron sensor or within a neutron-sensitive apparatus.

Embodiments of the scintillator stack obviate issues that occur with neutron sensors and neutron-sensitive apparatuses that have the neutron-sensitive particulate material dispersed in the same matrix as the scintillator particulate material as seen with conventional neutron sensors. Optimal sizes for each of the neutron-sensitive particulate material and the scintillator particulate material can be very different. Thus, in conventional neutron sensors, there is a risk that the neutron-sensitive particulate material and scintillator particulate material may segregate before the particulate material is thoroughly mixed within a matrix material leading to poor light output. One of the problems with such a segregated mixture is that its non-uniformity leads to a distribution in energy straggling that blurs the energy resolution and lowers detection efficiency. The energy carried away by charged particles can be deposited among the neutron-sensitive particulate material, the scintillator particulate material, and the polymer binder which varies from reaction to reaction due to the non-uniformity. The result is a wide distribution in the neutron energy spectrum as measured by the amount of scintillation light. However, for the scintillator stack as described herein, the neutron-sensitive particulate material can be in separate adjacent thin layers to avoid segregation within the matrix. This structure can overcome the above deficiency in conventional neutron sensors because a consistent repeating geometry can make the energy deposition into the scintillator particulate material more uniform from one reaction to another.

Potentially less neutron-sensitive and scintillator material may be used in a neutron sensor and still achieve an acceptable light output. Alternatively, higher light output may be achieved for substantially the same amount of neutron-sensitive and scintillator materials in a comparable conventional neutron sensor or neutron-sensitive apparatus. More details are provided below and are merely to illustrate some embodiments and not limit the concepts as described herein.

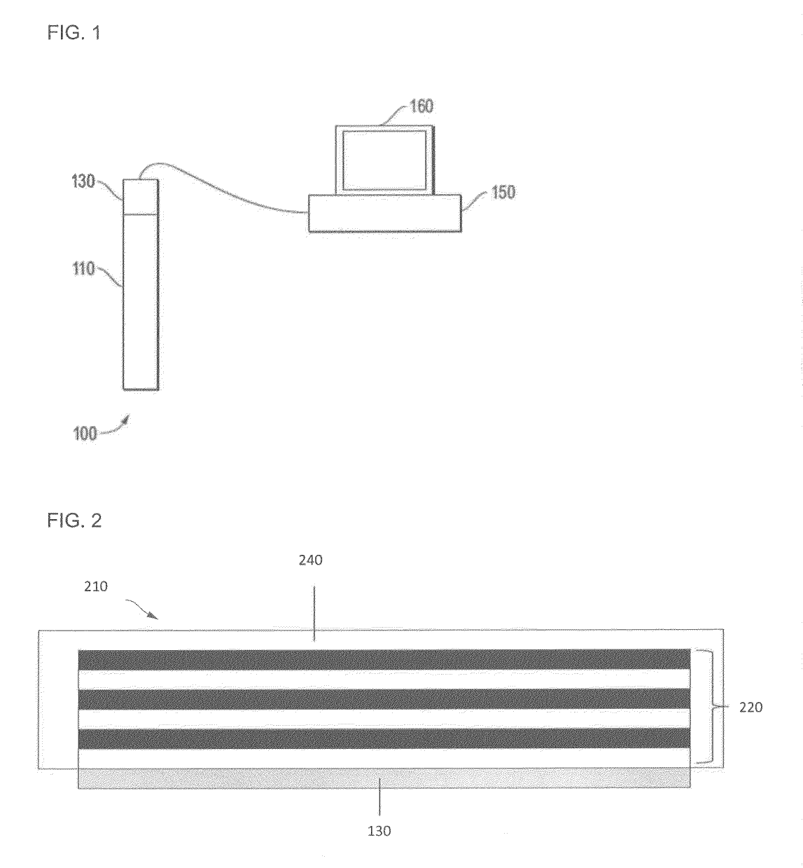

The scintillator stack can be used in a neutron sensor 110 that is part of a neutron-sensitive apparatus 100, as illustrated in FIG. 1. The neutron sensor 110 is optically coupled to a photosensor 130 that includes a photomultiplier tube or a semiconductor-based photomultiplier. The photosensor 130 is electronically coupled to computational circuitry 150. The computational circuitry 150 can receive and analyze the pulse data from the photosensor 130 to determine a number of neutron counts, a level of neutron radiation based on the identified number of neutron events, perform pulse shape discrimination, perform another suitable function, or the like.

Further, computational circuitry 150 can provide an indication of the number of neutron events, an indication of a level of neutron radiation, or provide other information to a user via an interface 160. For example, computational circuitry 150 can provide a visual display via interface 160 indicating a level of neutron radiation. The operation of the neutron-sensitive apparatus 100 is described in more detail following a description of an exemplary, non-limiting embodiment of the neutron sensor 110.

FIG. 2 includes a cross-sectional view of the neutron sensor 210 that includes a scintillator stack 220, wherein the scintillator stack 220 includes at least one neutron-sensitive layer in which the neutron-sensitive particulate material is dispersed and at least one scintillator layer in which the scintillator particulate material is dispersed. In another embodiment, the stack 220 can include more neutron-sensitive layers and scintillator layers. The neutron sensor can further include the photosensor 130 and a neutron moderator 240, each disposed on an outer surface of the scintillator stack 220. Optionally, an optical transmission member (not illustrated), a reflector (not illustrated), or both can be disposed on or optically connected to the scintillator stack 220.

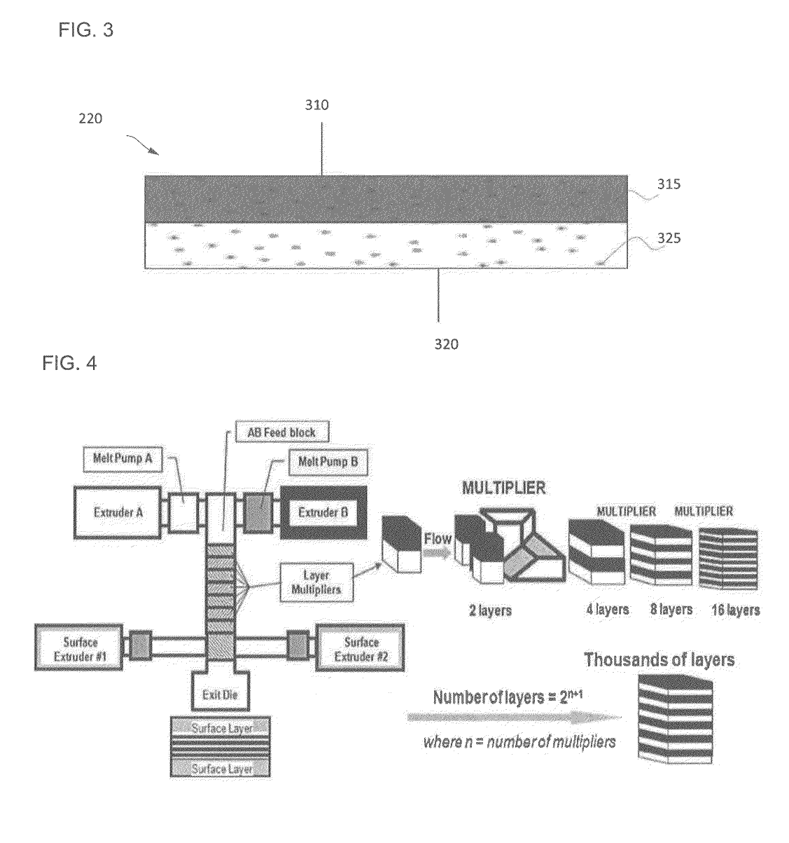

FIG. 3 includes an illustration of two layers of the scintillator stack 220 in accordance with an embodiment described herein. The layers of the scintillator stack 220 illustrated in FIG. 3 include a neutron-sensitive layer 310 and a scintillator layer 320. The neutron-sensitive layer 310 can include a neutron-sensitive particulate material 315 dispersed in a polymer matrix, and the scintillator layer 320 can include a scintillator particulate material 325 dispersed in a separate polymer matrix. Particular details regarding materials, particle sizes, thicknesses, and other considerations for the neutron-sensitive layer and the scintillator layer are described later in this specification.

In operation, neutrons can be sensed at the neutron sensor 110 of the neutron-sensitive apparatus 100. Fast neutrons, if any, that enter the neutron sensor are converted to thermal neutrons by the neutron moderator 240 (illustrated in FIG. 2). Thermal neutrons, if any, that enter the neutron sensor do not need to be converted to thermal neutrons by the neutron moderator 240, and therefore, pass through the neutron moderator 240. The thermal neutrons continue to migrate within the neutron sensor to the scintillator stacks 220.

The scintillator stack 220 can be configured such that neutron-sensitive particulate material 315 can capture a target radiation, such as a neutron. The capture of the neutron by the neutron-sensitive particulate material 315 can produce one or more secondary particulate material, such as an alpha particle, a triton particle, another suitable secondary particle, or any combination thereof. The secondary particulate material can exit the neutron-sensitive particulate material 315 and travel to the scintillator layer 320 to be captured by the scintillator particulate material 325. If the neutron-sensitive particulate material 315 and the scintillator material 325 would dispersed in the same polymer matrix, segregation could occur and the secondary particulate material may have to travel through a thick layer to reach the segregated scintillator particulate material and could lose a portion of its energy. By separating the neutron-sensitive particulate material 315 into a thin neutron-sensitive layer separate and adjacent to the scintillator layer 320, the distance that secondary particulate material travels before reaching the scintillator particulate material 325 in the scintillator layer 320 can be reduced while the chance that secondary particulate material can be captured by scintillator particulate material 325 for conversion into photons can be increased. Upon capture of the secondary particulate material, scintillator particulate material 325 can emit scintillation light such as photons.

Referring to FIG. 2, the scintillation light can leave the scintillator stacks 220 and be received by the photosensor 130 (illustrated in FIG. 1) or transmitted to the photosensor 130 via the optical transmission member (not illustrated). In another embodiment, the optical transmission member can convert the scintillation light to wavelength shifted light that is transmitted to the photosensor 130. Photons from the scintillation light or wavelength shifted light can be received by the photosensor 130, and the photosensor 130 generates an electronic pulse in response to receiving the photons. The electronic pulse is sent from the photosensor 130 and is received by the computational circuitry 150. The computational circuitry 150 can analyze or perform another function in response to receiving the electronic pulse from the photosensor 130. The computational circuitry can determine that a neutron has been captured and increment a neutron counter, determine a neutron radiation level, perform another suitable determination, analysis, or the like, or any combination thereof.

Particular designs for the neutron sensor 110 and neutron-sensitive apparatus 100 have been described. Other neutron sensors and neutron-sensitive apparatuses can be used with the scintillator stack 220. Thus, after reading this specification, skilled artisans will appreciate that the scintillator stack 220 can be implemented in many different neutron sensors and neutron-sensitive apparatuses without departing from the scope of the present invention.

Attention is now directed to the scintillator stack that can be used in neutron sensors and neutron-sensitive apparatuses. As stated previously, the scintillator stack can include a neutron-sensitive layer and a scintillator layer. The scintillator stack can include more than one neutron-sensitive layers, more than one scintillator layers, or both. In an embodiment, the scintillator stack can include a plurality of neutron-sensitive layers alternated with scintillator layers. The number of neutron-sensitive layers in the scintillator stack can be the same as or different than the number of scintillator layers in the scintillator stack.

Increasing the number of layers in the scintillator stack can improve the light output of a neutron sensor. In an embodiment, the number of each of neutron-sensitive layers and scintillator layers can be at least one, at least three, at least five, at least seven, or at least nine. On the other hand, having too many layers can make it difficult for the scintillation light to propagate through the layers. Thus, in a further embodiment, the number of each of neutron-sensitive and scintillator layers may be no greater than twenty-one, no greater than nineteen, no greater than seventeen, or no greater than fifteen. In a particular embodiment, the number of each of neutron-sensitive and scintillator layer can be three to twenty-one, from five to nineteen, from seven to seventeen, or from nine to fifteen.

In an embodiment, the first and the last layer in the stack can be a layer of the same material, such as where the neutron-sensitive layers are alternated with scintillator layers, both first and last layers can be scintillator layers or both first and last layers can be neutron-sensitive layers. In other words, the number of neutron-sensitive layers in the scintillator stack can be represented by “n” and the number of scintillator layers in the scintillator stack can be represented by “n+1” or “n−1.” It may be advantageous to include scintillator layers as the first and last layers in the stack to be more proximate to optical transmission members or photosensors of the neutron sensor. Thus, in a particular embodiment, the number of scintillator layers in the scintillator stack is “n+1.”

The neutron-sensitive layer can include a neutron-sensitive particulate material. The neutron-sensitive particulate material can emit a charged particle, such as a positively charged particle, in response to absorbing a neutron. The positively charged particle can include an alpha particle, a triton particle, a protron, a ⁷Li particle, a fission particle, or any combination thereof.

In an embodiment, the neutron-sensitive particulate material can include neutron responsive atoms such as ⁶Li or ¹⁰B. For example, the neutron-sensitive particulate material can include a neutron responsive element that is in elemental form (not part of a compound) or as part of a halide compound, a phosphate compound, a silicate compound, or any combination thereof. In a particular embodiment, the neutron-sensitive particle can include ⁶LiF, ⁶Li₃PO₄, ⁶Li₄SiO₄, elemental ¹⁰B, ¹⁰BN, a ¹⁰B oxide, ¹⁰B₄C, or any combination thereof. In a more particular embodiment, neutron-sensitive particulate material includes ⁶LiF.

The neutron-sensitive particulate material can include a variety of shapes, including spherical particulate material and non-spherical particulate material, and a variety of averaged particulate material sizes. The neutron-sensitive particulate material can have an averaged particle size such that neutrons can be captured. In an embodiment, the neutron-sensitive particulate material has an averaged particle size of at least 0.2 microns, at least 0.5 microns, at least 0.9, at least 2 microns, or at least 3 microns. Still, the averaged particle size of the neutron-sensitive particulate material should be relatively small to reduce energy lost by the secondary particulate material as it travels from the point of origin to another point outside of the neutron-sensitive layer. In another embodiment, the neutron-sensitive particulate material has an averaged particle size of no greater than approximately 25 microns, no greater than 15 microns, no greater than 9 microns, or no greater than 7 microns. In a particular embodiment, the neutron-sensitive particulate material has an averaged particle size of 0.2 to 25 microns, 0.5 to 15 microns, or 0.5 to 7 microns. The averaged particle size of spherical neutron-sensitive particulate material is measured using the diameter of the particulate material. The averaged particle size of non-spherical neutron-sensitive particulate material is measured using any other suitable dimensions, such as a length, a width, or a cube root of the volume of the particle.

As stated previously, the neutron-sensitive particulate material can be dispersed in a matrix material to provide the neutron-sensitive layer. In an embodiment, the matrix material can be a polymer matrix including a transparent polymer. In an embodiment, the polymer can include an epoxy, a polyvinyl toluene (PVT), a polystyrene (PS), a polymethylmethacrylate (PMMA), a polyvinylcarbazole (PVK), a polybutyrate (such as cellulose acetate butyrate), a polycarbonate, a polyurethane, a glycol modified polyethylene terphthalate (PETG), or any combination thereof. Commercially available polycarbonates include those sold by SABIC Innovative Plastics (Pittsfield, Mass.) under the trade name LEXAN™.

The loading of the neutron-sensitive particulate material in the polymer matrix of the neutron-sensitive layer should be sufficient to provide enough neutron-sensitive particulate material to capture a high amount of neutrons. However, the loading should be sufficient to allow the emitted charged particulate material to exit the neutron-sensitive layer. In an embodiment, the ratio by weight of neutron-sensitive particulate material:polymer in the neutron-sensitive layer is at least 0.85:1, at least 0.90:1, or at least 0.95:1. In another embodiment, the ratio by weight of neutron-sensitive particulate material:polymer in the neutron-sensitive layer is no greater than 1.25:1, no greater than 1.15:1, or no greater than 1.05:1. In yet another embodiment, the ratio by weight of neutron-sensitive particulate material:polymer in the neutron-sensitive layer is from 0.85:1 to 1.24:1, from 0.90:1 to 1.15:1, or from 0.95:1 to 1.05:1.

The neutron-sensitive layer can have a thickness sufficient to contain the neutron-sensitive particulate material. In an embodiment, the neutron-sensitive layer can have a thickness of at least 1 micron, at least 2 microns, at least 3 microns, at least 4 microns, or at least 5 microns. The neutron-sensitive layer should be thin enough to allow the charged particulate material emitted from the neutron-sensitive material to pass through to the scintillator layer without significant energy loss. In a further embodiment, the neutron-sensitive layer may have a thickness of no greater than 100 microns, no greater than 50 microns, no greater than 25 microns, no greater than 15 microns, no greater than 9 microns, or no greater than 7 microns. In a particular embodiment, the neutron-sensitive layer can have a thickness of 1 to 100 microns, 3 to 25 microns, or 5 to 15 microns. When the neutron-sensitive layer includes multiple layers, the averaged thickness of the neutron-sensitive layers can include the above ranges.

The scintillator layer can include a scintillator particulate material. The scintillator particulate material can include an inorganic scintillator compound, an organic scintillator compound, or any combination thereof, that produces photons in response to capturing a secondary particle. In an embodiment, the scintillator particulate material may have a relatively low sensitivity to gamma radiation.

Utilizing only elements having a low atomic number, such as below 50, even below 40, can reduce the sensitivity of the scintillator stack to gamma rays. For example, the scintillator layer can incorporate an inorganic substance such as a ZnS, a CdS, a ZnCdS, a ZnO, a MgS, a CaS, a SrS, a BaS, a yttrium aluminum garnet (YAG, Y₃Al₅O₁₂), a yttrium aluminum perovskite (Y₍₂₋₂ₓ₎Al₂ₓO₃), a MgF₂, a CaF₂, a CsF, a SrF₂, a BaF₂, a rare earth oxyorthosilicate, a CaWO₄, any combination thereof, or another inorganic substance to produce scintillation light in response to capturing a secondary particle. In a particular embodiment, the scintillator layer includes ZnS. An example of an organic scintillator compound includes anthracene, a scintillator plastic, or another organic substance to produce scintillation light in response to capturing a secondary particle. Additionally, the scintillator particulate material can include a dopant or another added impurity, such as a transition metal, a rare earth metal, or another metal. For example, the scintillator layer can include ZnS:Ag, ZnS:Cu, Y₂SiO₅:Ce, ZnO:Ga, or ZnCdS:Cu. In a particular embodiment, the scintillator layer includes ZnS:Ag. In another particular embodiment, the scintillator layer includes ZnS:Cu.

The scintillator particulate material can include a variety of shapes, including spherical particulate material and non-spherical particulate material, and a variety of averaged particulate material sizes. The scintillator particulate material has an averaged particle size so that neutrons can be captured. In an embodiment, the scintillator particulate material has an averaged particle size of at least 1 micron, at least 5 microns, at least 15 microns, or at least 25 microns. Still, the averaged particle size of the scintillator particulate material should be relatively small to maintain a thin layer to shorten the distance the scintillation light travels to exit the scintillation layer. In another embodiment, the scintillator particulate material has an averaged particle size of no greater than 75 microns, no greater than 55 microns, no greater than 45 microns, or no greater than 35 microns. In a particular embodiment, the scintillator particulate material has an averaged particle size of 5 to 75 microns, 15 to 55 microns, or 25 to 35 microns. The averaged particle size of spherical scintillator particulate material is measured using the diameter of the particulate material. The averaged particle size of non-spherical scintillator particulate material is measured using any other suitable dimensions, such as a length, a width, or a cube root of the volume of the particle.

The scintillator particulate material can be dispersed in a matrix material to provide the scintillator layer. In an embodiment, the matrix material can be a polymer matrix including a transparent polymer. The polymer of the scintillator can include one or more of any of the polymers used for the neutron-sensitive layer. The polymer matrix of the neutron-sensitive layer can be made from the same or different material as compared to the polymer matrix of the scintillator layer. In a particular embodiment, polymer matrix of the neutron-sensitive layer is made from a material that is different than the material used to make the polymer matrix of the scintillator layer.

The loading of the scintillator particulate material in the polymer matrix of the scintillator layer should be sufficient provide enough scintillator particulate material to capture a high amount of the energy of charged particles emitted from the neutron-sensitive material. However, the stack can be made according to a co-extrusion process discussed below and too much filler make the polymer too thick for extrusion. Thus, the loading should be sufficient to allow proper flow during the extrusion process.

The loading of the scintillator layer can be represented by a ratio by weight of scintillator particulate material:polymer in the scintillator layer. In an embodiment, the ratio is at least 0.85:1, at least 0.90:1, or at least 0.95:1. In another embodiment, the ratio is no greater than 1.25:1, no greater than 1.15:1, or no greater than 1.05:1. In yet another embodiment, the ratio is from 0.85:1 to 1.24:1, from 0.90:1 to 1.15:1, or from 0.95:1 to 1.05:1.

The loading of a particulate material in a layer can be represented by a filling fraction, which is the concentration by volume of particulate material in a layer. In an embodiment, the filling fraction for the scintillator layer can be at least 5%, at least 15%, or at least 25%. In another embodiment, the filling factor may be no greater than 55%, no greater than 50%, or no greater than 45%. In yet another embodiment, the filling factor can be 5% to 55%, 15% to 50%, or 25% to 45%. A filling fraction above 45% may begin to deteriorate the structural stability of the layer or inhibit the flow of the material during extrusion.

The loading of the neutron-sensitive layer can be represented by the same ranges for the above ratio by weight or filling fraction by volume of the scintillator layer.

The scintillator layer can have a thickness sufficient to contain the scintillator particulate material. In an embodiment, the scintillator layer can have a thickness of at least 5 microns, at least 15 microns, or at least 25 microns. The scintillator layer should be thin enough to allow the scintillation light emitted from the scintillator particulate material to pass through to the scintillator layer without significant energy loss. In a further embodiment, the scintillator layer may have a thickness of no greater than 100 microns, no greater than 85 microns, no greater than 55 microns, no greater than 45 microns, or no greater than 35 microns. In a particular embodiment, the scintillator layer can have a thickness of 5 to 100 microns, 15 to 55 microns, or 25 to 35 microns. When the scintillator stack includes multiple scintillator layers, the averaged thickness of the scintillator layers in the scintillator stack can include the above ranges.

The overall thickness of the scintillator stack is dependent on the number of layers in the stack and the thickness of each of those layers. The stack can have a thickness of at least 0.05 mm, at least 0.1 mm, at least 0.15 mm, or at least 0.25 mm. The scintillator stack should be thin enough to allow the scintillation light to propagate through the layers. The stack may have a thickness of no greater than 5 mm, no greater than 3 mm, no greater than 1 mm, or no greater than 0.75 mm. In a particular embodiment, the scintillator stack can have a thickness of 0.05 to 5 mm, 0.1 to 3 mm, or 0.25 to 0.75 mm.

The scintillator stack described herein can be manufactured using a co-extrusion method, such as a forced assembly multilayer co-extrusion method. Forced assembly multilayer co-extrusion includes co-extrusion of a plurality of polymers in a layered feed-block and additional layer multiplication accomplished through a series of multiplier dies. The multilayer co-extrusion method can create thousands of alternating layers of different polymers. Layer thicknesses can be approximately a few tens of nanometers.

FIG. 4 includes a schematic of an embodiment of the method. The method can include providing an extrudable neutron-sensitive material into Extruder A and providing an extrudable scintillator material into Extruder B. The extrudable materials are heated and fed through Melt Pump A or B into the AB feed block. The heated extrudable materials can be subjected to one or more multiplier extrusions dies to create the desired structure. For example, the two layer structure can be cut in half, softened, and pressed to form a 4-layer structure, and then an 8-layer structure, and then a 16-layer structure, and so on. The number of layers formed can be equal to 2^{x+1} where x is the number of multipliers. Once the desired number of layers have been formed, Surface Extruder #1 and Surface Extruder #2 apply a surface layer to the first and last layer of the multilayer stack. The multilayer stack exits the extruder through the Exit Die.

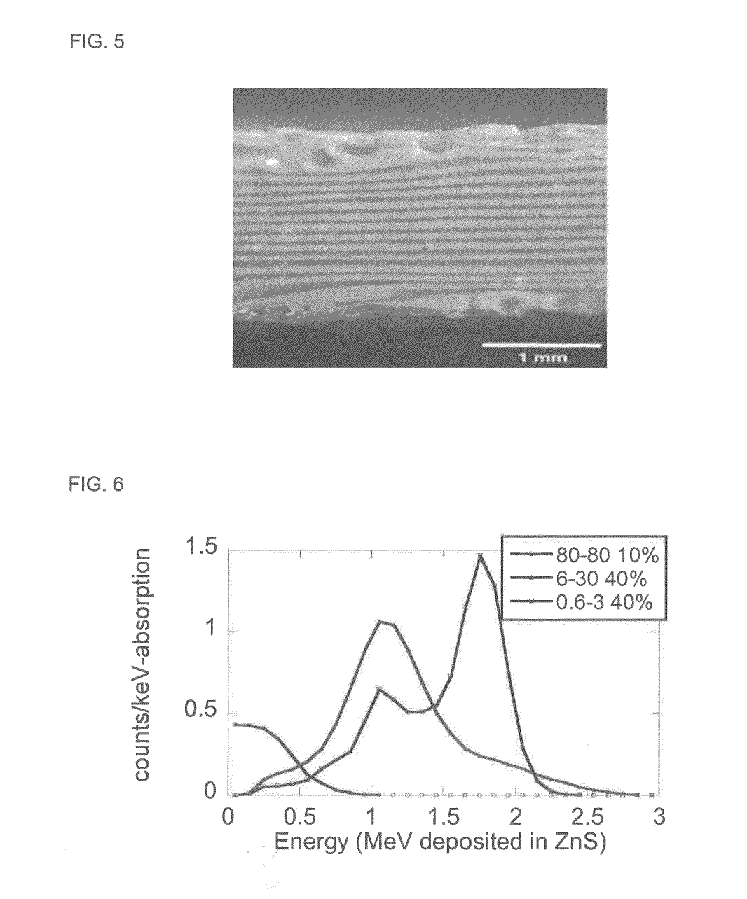

FIG. 5 includes an optical microscope image of a multilayer stack made according to the method described above. The stack is made of 32 alternating layers of PMMA filled with ZnS:Ag (darker bands) and LiF (lighter bands), respectively. Each layer having a thickness of 80 microns and the filling fraction is 10%. The LiF is 95% enriched ⁶Li.

FIG. 6 includes a graph describing simulations performed using Monte Carlo N-Particle (MCNP) software to characterize the expected energy deposition distributions into a ZnS scintillator. The simulations were performed for three 32 layer PMMA films of varying layer thickness and filling fraction. The first example has 80 m LiF layers, 80 m ZnS layers, and 10% volume loading (80-80 10%); The second example has 6 m LiF layers, 30 m ZnS layers, and 40% volume loading (6-30 40%). The third example has 0.6 m LiF layers, 3 m ZnS layers, and 40% volume loading (0.6-3 40%). The graph plots the energy deposition spectra per ⁶Li-neutron reaction for made for each of the above examples. Note that the shapes and positions of these curves can be adjusted by varying the thicknesses and filling fractions. The simulations for the 6-30 40% example and the 0.6-3 40% example exhibited a smaller fraction of low energy depositions as compared to the 80-80 10% example.

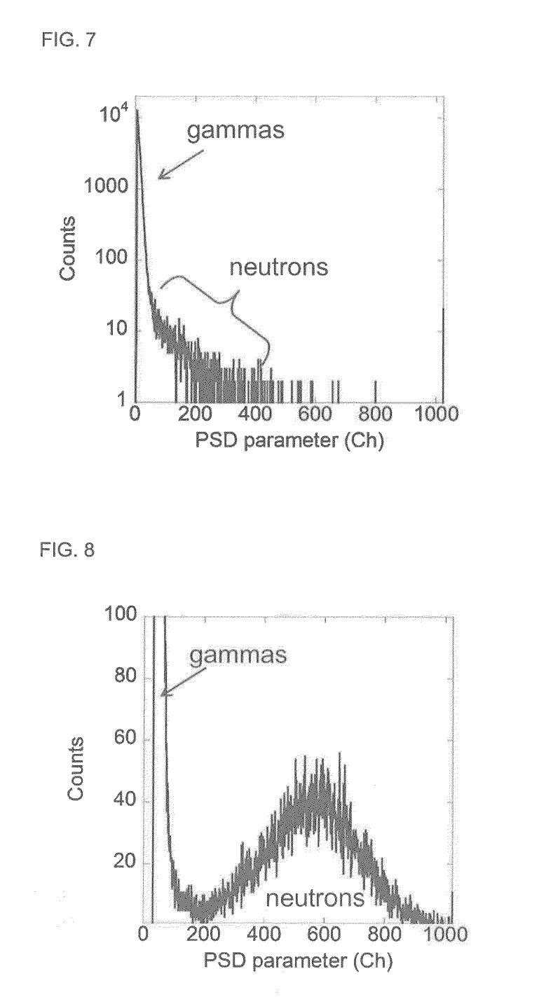

FIG. 7 includes a histogram graph describing the energy spectrum of the multilayer stack illustrated in FIG. 5. The energy spectrum was created using the following procedure. A 3×3 cm² section was cut from the extrusion and coupled to a to a photomultiplier tube (PMT) and an analog-to digital converter (ADC) and multichannel analyzer (MCA) system. The PMT used was a Photonis XP20Y0 (8-stage) operated at −900V. The PMT output was fed to a fast preamplifier and thence to the MCA (Aptek model 55008, bi-polar shaping, 4 micro-s shaping time, 11-bit digitization). A ²⁵²Cf isotopic neutron/gamma source (42.7 nanograms, emitting 98860 neutrons/s) was placed 30 cm from the extrusion. Between the source and the extrusion was 5 cm of high density polyethylene to moderate the neutrons and 6 mm of lead (Pb) to reduce the flux of low energy gamma rays which cause pulse pile-up in the PMT.

FIG. 8 includes a histogram graph describing the pulse shape spectrum of the multilayer stack illustrated in FIG. 5. The pulse shape spectrum was created using the same procedure and equipment as the energy spectrum measurement with the following additions: The pulse from the PMT was input to a Delay Line Amplifier (DLA, model: ORTEC 460) with an integration time set to 250 ns. The output of the DLA was input to a Pulse Shape Analyzer (PSA, model: ORTEC 552) set to trailing edge constant fraction timing (constant fraction=0.9). The output of the PSA was sent to a Time-to-Amplitude Converter (TAC, model: ORTEC 567). In this configuration, the TAC output is a pulse having an amplitude proportional to a Time Interval (TI) and the TI is proportional the time required for the integrated PMT pulse to rise from 10% to 90% of its total value over the first 250 ns. The TAC output was then sent to the ADC+MCA system (model: Aptec s5008).

The histogram illustrated in FIG. 7 includes two distinct regions corresponding to the lower intensity scintillation light coming from the gamma interactions and the higher intensity scintillation light coming from the neutron interactions, which indicates that neutrons will appear a higher energies than gammas for the multilayer stack illustrated in FIG. 5. The histogram illustrated in FIG. 8 also includes two distinct regions corresponding to the shorter TI coming from the gamma interactions and the longer TI coming from the neutron interactions. The results illustrated by the histograms of FIGS. 7 and 8 confirm that a multilayer stack formed according to the multilayer co-extrusion method described herein can operate to detect neutrons.

The present invention has several advantages. The scintillator particulate material can be uniformly separated from the neutron-sensitive material in a into a repeating geometry which will make the energy deposition into the scintillator particulate material more uniform from one reaction to another. This uniformity can increase the efficiency of the neutron sensor in detecting secondary particles and yielding scintillation light. In addition, the repeating geometry can include several thin layers. Thus, the secondary charged particles do not need to travel through a thick polymer matrix in order to interact with the scintillator particulate material, which can eliminate more of the energy loss of the secondary charged particles in the polymer matrix.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa. Embodiments may be in accordance with any one or more of the items as listed below. Embodiments may be in accordance with any one or more of the items as listed below.

Item 1. A scintillator stack comprising:
a neutron-sensitive particulate material; and
a scintillator particulate material,
wherein the neutron-sensitive particulate material is dispersed in a neutron-sensitive layer and the scintillator particulate material is dispersed in a separate scintillator layer.

Item 2. A scintillator stack comprising:
a neutron-sensitive layer; and
a scintillator layer,
wherein the neutron-sensitive layer does not include a scintillator material.

Item 3. A scintillator stack comprising:
a neutron-sensitive layer; and
a scintillator layer comprising zinc,
wherein the scintillator layer does not include a neutron-sensitive material.

Item 4. A scintillator stack comprising:
a neutron-sensitive layer having a thickness of less than 100 microns; and
a scintillator layer having a thickness of less than 100 microns.

Item 5. A scintillator stack comprising:
at least one neutron-sensitive layer; and
at least one scintillator layer,
wherein the number of the neutron-sensitive layers in the stack is represented by n, the number of scintillator layers in the stack is represented by n+1, and n is a positive integer of 10 or greater.

Item 6. A method of making a scintillator stack, the method comprising:
providing an extrudable neutron-sensitive material;
providing an extrudable scintillator material;
co-extruding a neutron-sensitive layer comprising the neutron-sensitive material and a scintillator layer including the scintillator material.

Item 7. The method of item 6, wherein the co-extruding includes forced polymeric micro-layer co-extrusion.

Item 8. The stack, device, or method of any one of items 1 or 3-7, wherein the neutron-sensitive layer does not include a scintillator material.

Item 9. The stack, device, or method of any one of items 1, 2, or 4-8, wherein the scintillator layer does not include a neutron-sensitive material.

Item 10. The stack, device, or method of any one of the preceding items, wherein the stack comprises alternating layers including the neutron-sensitive layer and the scintillator layer.

Item 11. The stack, device, or method of any one of the preceding items, wherein the stack comprises more than one scintillator layer.

Item 12. The stack, device, or method of any one of the preceding items, wherein the stack comprises more than one neutron-sensitive layer.

Item 13. The stack, device, or method of items 11 or 12, wherein each of the neutron-sensitive layers is alternated with one of the scintillator layers.

Item 14. The stack, device, or method of any one of the preceding items, wherein the neutron-sensitive particulate material emits a charged particle in response to absorbing a neutron.

Item 15. The stack, device, or method of any one of the preceding items, wherein the neutron-sensitive layer includes a neutron-sensitive particulate material that emits a positively charged particle in response to absorbing a neutron.

Item 16. The stack, device, or method of item 15, wherein the positively charged particle includes an alpha particle, a triton particle, a proton, a ⁷Li particle, or fission particle, or any combination thereof.

Item 17. The stack, device, or method of any one of any one of the preceding items, wherein the neutron-sensitive layer includes a neutron-sensitive particulate material including a compound containing a neutron-responsive element including ⁶Li, ¹⁰B, or a combination thereof.

Item 18. The stack, device, or method of item 17, wherein the neutron-responsive element includes ⁶Li.

Item 19. The stack, device, or method of item 17 or 18, wherein the neutron-responsive compound includes 6LiF.

Item 20. The stack, device, or method of any one of any one of the preceding items, wherein the neutron-sensitive layer includes a neutron-sensitive particulate material having an averaged particle size of at least 0.2 microns, at least 0.5 microns, at least 0.9, at least 2 microns, or at least 3 microns.

Item 21. The stack, device, or method of any one of any one of the preceding items, wherein the neutron-sensitive layer includes a neutron-sensitive particulate material having an averaged particle size of no greater than approximately 25 microns, no greater than 15 microns, no greater than 9 microns, or no greater than 7 microns.

Item 22. The stack, device, or method of any one of any one of the preceding items, wherein the neutron-sensitive layer includes a neutron-sensitive particulate material having an averaged particle size of 0.2 to 25 microns, 0.5 to 15 microns, or 0.5 to 7 microns.

Item 23. The stack, device, or method of any one of the preceding items, wherein the scintillator layer includes a scintillator particulate material that emits a photon in response to capturing a positively charged particle.

Item 24. The stack, device, or method of item 23, wherein the positively charged particle includes an alpha particle, a triton particle, a proton, a ⁷Li particle, or fission particle, or any combination thereof.

Item 25. The stack, device, or method of any one of the preceding items, wherein the scintillator layer includes a scintillator particulate material including an inorganic scintillator material.

Item 26. The stack, device, or method of any one of the preceding items, wherein the scintillator layer includes a scintillator particulate material including a ZnS, a ZnO, a ZnCdS, a CdS, a CaS, a BaS, a SrS, a MgS, a MgF₂, a CaF₂, a CsF, a SrF₂, a BaF₂, a Y₃Al₅O₁₂, a YAlO₃, a Gd₂SiO₅, a CaWO₄, a rare earth oxyorthosilicate, or any combination thereof.

Item 27. The stack, device, or method of any one of the preceding items, wherein the scintillator layer includes a scintillator particulate material including ZnS.

Item 28. The stack, device, or method of any one of the preceding items, wherein the scintillator layer includes a scintillator particulate material having an averaged particle size of at least 1 micron, at least 5 microns, at least 15 microns, or at least 25 microns

Item 29. The stack, device, or method of any one of the preceding items, wherein the scintillator layer includes a scintillator particulate material having an averaged particle size of no greater than 75 microns, no greater than 55 microns, no greater than 45 microns, or no greater than 35 microns

Item 30. The stack, device, or method of any one of the preceding items, wherein the scintillator layer includes a scintillator particulate material having an averaged particle size of 5 to 75 microns, 15 to 55 microns, or 25 to 35 microns.

Item 31. The stack, device, or method of any one of the preceding items, wherein the scintillator stack includes n neutron-sensitive layers, where n is an integer of at least 3, at least 5, at least 7, and least 9, or at least 11.

Item 32. The stack, device, or method of any one of the preceding items, wherein the scintillator stack includes n neutron-sensitive layers, where n is an integer of greater than 21, no greater than 19, no greater than 17, or no greater than 15.

Item 33. The stack, device, or method of any one of the preceding items, wherein the scintillator stack includes n neutron-sensitive layers, where n is an integer from 3 to 21, from 5 to 19, from 7 to 17, or from 9 to 15.

Item 34. The stack, device, or method of any one of the preceding items, wherein the neutron-sensitive layers have an average thickness of no greater than 100 microns, no greater than 50 microns, no greater than 25 microns, no greater than 15 microns, no greater than 9 microns, or no greater than 7 microns.

Item 35. The stack, device, or method of any one of the preceding items, wherein the neutron-sensitive layers have an average thickness of at least 1 micron, at least 2 microns, at least 3 microns, at least 4 microns, or at least 5 microns.

Item 36. The stack, device, or method of any one of the preceding items, wherein the neutron-sensitive layers have an average thickness of 1 to 100 microns, 3 to 25 microns, or 5 to 15 microns.

Item 37. The stack, device, or method of any one of the preceding items, wherein the scintillator layers have an average thickness of no greater than 100 microns, no greater than 85 microns, no greater than 55 microns, no greater than 45 microns, or no greater than 35 microns.

Item 38. The stack, device, or method of any one of the preceding items, wherein the scintillator layers have an averaged thickness of at least 5 microns, at least 15 microns, or at least 25 microns.

Item 39. The stack, device, or method of any one of the preceding items, wherein the scintillator layers have an average thickness of 5 to 100 microns, 15 to 55 microns, or 25 to 35 microns.

Item 40. The stack, device, or method of any one of the preceding items, wherein the neutron-sensitive layers include a neutron-sensitive particulate material dispersed in a polymer matrix.

Item 41. The stack, device, or method of any one of the preceding items, wherein the neutron-sensitive layer includes a neutron-sensitive particulate material dispersed in a polymer matrix, the polymer including a transparent polymer.

Item 42. The stack, device, or method of any one of the preceding items, wherein the neutron-sensitive layer includes a neutron-sensitive particulate material dispersed in a transparent polymer matrix, the polymer including a polyvinyl toluene (PVT), a polystyrene (PS), a polymethylmethacrylate (PMMA), an epoxy, a polybutyrate, polycarbonate, a polyurethane, a glycol modified polyethylene terphthalate (PETG), or any combination thereof.

Item 43. The stack, device, or method of any one of the preceding items, wherein scintillator layer includes a scintillator particulate material dispersed in a polymer matrix.

Item 44. The stack, device, or method of any one of the preceding items, wherein the scintillator layer includes a scintillator particulate material dispersed in a polymer matrix, the polymer including a transparent polymer.

Item 45. The stack, device, or method of any one of the preceding items, wherein the scintillator layer includes a scintillator particulate material dispersed in a polymer matrix, the polymer including a PVT, a PS, a PMMA, an epoxy, a polybutyrate, polycarbonate, a polyurethane, a PETG, or any combination thereof.

Item 46. The stack, device, or method of any one of the preceding items, wherein the scintillator layer includes a scintillator particulate material dispersed in a first polymer matrix and the neutron-sensitive layer includes a neutron-sensitive particulate materials dispersed in a second polymer matrix, the polymer of the first polymer matrix being different than the polymer of the second polymer matrix.

Item 47. The stack, device, or method of any one of the preceding items, wherein the scintillator layer includes a scintillator particulate material dispersed in a first polymer matrix and the neutron-sensitive layer includes a neutron-sensitive particulate materials dispersed in a second polymer matrix, the polymer of the first polymer matrix being the same as the polymer of the second polymer matrix.

Item 48. The stack, device, or method of any one of the preceding items, wherein the ratio by weight of particulate material:polymer in the scintillator layer is at least 0.85:1, at least 0.90:1, or at least 0.95:1.

Item 49. The stack, device, or method of any one of the preceding items, wherein the ratio by weight of particulate material:polymer in the scintillator layer is no greater than 1.25:1, no greater than 1.15:1, or no greater than 1.05:1.

Item 50. The stack, device, or method of any one of the preceding items, wherein the ratio by weight of particulate material:polymer in the scintillator layer is from 0.85:1 to 1.24:1, from 0.90:1 to 1.15:1, or from 0.95:1 to 1.05:1.

Item 51. The stack, device, or method of any one of the preceding items, wherein the ratio by weight of particulate material:polymer in the neutron-sensitive layer is at least 0.85:1, at least 0.90:1, or at least 0.95:1.

Item 52. The stack, device, or method of any one of the preceding items, wherein the ratio by weight of particulate material:polymer in the neutron-sensitive layer is no greater than 1.25:1, no greater than 1.15:1, or no greater than 1.05:1.

Item 53. The stack, device, or method of any one of the preceding items, wherein the ratio by weight of particulate material:polymer in the neutron-sensitive layer is from 0.85:1 to 1.24:1, from 0.90:1 to 1.15:1, or from 0.95:1 to 1.05:1.

Item 54. The stack, device, or method of any one of the preceding items, wherein the stack has a thickness of at least 0.05 mm, at least 0.1 mm, at least 0.15 mm, or at least 0.25 mm.

Item 55. The stack, device, or method of any one of the preceding items, wherein the stack has a thickness of no greater than 5 mm, no greater than 3 mm, no greater than 1 mm, or no greater than 0.75 mm.

Item 56. The stack, device, or method of any one of the preceding items, wherein the stack has a thickness of 0.05 to 5 mm, 0.1 to 3 mm, or 0.25 to 0.75 mm.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A scintillator stack comprising:
a neutron-sensitive particulate material; and
a scintillator particulate material,
wherein the neutron-sensitive particulate material is dispersed in a neutron-sensitive layer and the scintillator particulate material is dispersed in a separate scintillator layer.

2. The scintillator stack of claim 1, wherein the neutron-sensitive layer does not include a scintillator material.

3. The scintillator stack of claim 1, wherein the scintillator layer does not include a neutron-sensitive material.

4. The scintillator stack of claim 1, wherein the stack comprises alternating layers including the neutron-sensitive layer and the scintillator layer.

5. The scintillator stack of claim 1, wherein the stack comprises more than one scintillator layer, more than one neutron-sensitive layer, and each of the neutron-sensitive layers is alternated with one of the scintillator layers.

6. The scintillator stack of claim 1, wherein the neutron-sensitive layer has a thickness of less than 100 microns and the scintillator layer has a thickness of less than 100 microns.

7. The scintillator stack of claim 1, wherein the neutron-sensitive layer includes a neutron-sensitive particulate material having an averaged particle size of at least 0.2 microns.

8. The scintillator stack of claim 1, wherein the scintillator layer includes a scintillator particulate material that emits a photon in response to capturing a positively charged particle.

9. The scintillator stack of claim 8, wherein the positively charged particle includes an ⁷Li particle.

10. The scintillator stack of claim 1, wherein the scintillator layer includes a scintillator particulate material including an inorganic scintillator material.

11. The scintillator stack of claim 10, wherein the scintillator layer includes a scintillator particulate material including ZnS.

12. The scintillator stack of claim 1, wherein the scintillator layer includes a scintillator particulate material having an averaged particle size of at least 1 micron.

13. The scintillator stack of claim 1, wherein the scintillator stack includes n neutron-sensitive layers, where n is an integer of at least 3.

14. The scintillator stack of claim 1, wherein the scintillator stack includes a plurality of the neutron-sensitive layers having an average thickness of no greater than 100 microns.

15. The scintillator stack of claim 1, wherein the scintillator stack includes a plurality of scintillator layers having an average thickness of no greater than 100 microns.

16. The scintillator stack of claim 1, wherein the neutron-sensitive layer includes the neutron-sensitive particulate material dispersed in a polymer matrix.

17. The scintillator stack of claim 1, wherein scintillator layer includes the scintillator particulate material dispersed in a polymer matrix.

18. A scintillator stack comprising:
at least one neutron-sensitive layer; and
at least one scintillator layer,
wherein the number of the neutron-sensitive layers in the stack is represented by n, the number of scintillator layers in the stack is represented by n+1, and n is a positive integer of 10 or greater.

19. A method of making a scintillator stack, the method comprising:
providing an extrudable neutron-sensitive material;
providing an extrudable scintillator material;
co-extruding a neutron-sensitive layer comprising the neutron-sensitive material and a scintillator layer including the scintillator material.

20. The method of claim 19, wherein the co-extruding includes forced polymeric micro-layer co-extrusion.
